(19) United States
(12) Patent Application Publication
(10) Pub. No.: US 2014/0106625 A1
(43) Pub. Date: Apr. 17, 2014

(54) CONNECTOR AND MANUFACTURING METHOD OF CONNECTOR

(71) Applicant: Yazaki Corporation, Tokyo (JP)

(72) Inventors: Hajime KATO, Kakegawa-shi (JP); Masayuki KATAOKA, Kakegawa-shi (JP); Hiroki KOMATSU, Kakegawa-shi (JP); Takeshi INNAN, Kakegawa-shi (JP)

(73) Assignee: Yazaki Corporation, Tokyo (JP)

(21) Appl. No.: 14/132,604

(22) Filed: Dec. 18, 2013

Related U.S. Application Data
(63) Continuation of application No. PCT/JP2012/070720, filed on Aug. 8, 2012.

(30) Foreign Application Priority Data
Aug. 11, 2011 (JP) 2011-176083

(51) Int. Cl. H01R 13/405

(52) U.S. Cl. CPC H01R 13/405
USPC 439/736; 264/272.14

(57) ABSTRACT

A connector is fixed in the vicinity of a distal end to which a conductor of a wire harness is exposed. The connector includes a primary molded part and a secondary molded part. The primary molded part is annularly molded by injection molding so as to cover the whole periphery of a part of a coating part in a state separated from the distal end. Also, a stopper is formed in a top part of the primary molded part. The secondary molded part is annularly molded by an injection molding method so as to cover the whole peripheries of a part of the coating part in the vicinity of the distal end and the portion excluding the top part of the primary molded part.

### CROSS REFERENCE TO RELATED APPLICATIONS

This application is a continuation of PCT application No. PCT/JP2012/070720, which was filed on Aug. 8, 2012 based on Japanese patent application (patent application 2011-176083) filed on Aug. 11, 2011, the contents of which are incorporated herein by reference. Also, all the references cited herein are incorporated as a whole.

### BACKGROUND OF THE INVENTION

1. Technical Field

The present invention relates to a connector which is mounted in a vehicle etc. and is fixed integrally to a wire harness, and a manufacturing method of the connector.

2. Background Art

A connector which is mounted in a vehicle etc. and is fixed integrally to a wire harness, and a manufacturing method of the connector are known. One example of this kind of connector is shown in FIG. 4 (see Japanese Patent Publication No. JP-A-2008-269858).

FIG. 4 is a sectional view showing a conventional connector. A connector 100 is formed in a distal end of a wire harness 200, and includes a primary molded part 300 with which a conductor 210 and a coating part 220 of the wire harness 200 are covered, and a secondary molded part 400 with which the primary molded part 300 and the coating part 220 are covered. Also, the connector 100 includes a first sealing member A arranged in the portion of bonding between the primary molded part 300 and the coating part 220, this bonding portion sealed with the first sealing member A, and a second sealing member B arranged in the portion of bonding between the secondary molded part 400 and the coating part 220, this bonding portion sealed with the second sealing member B. The fact that the primary molded part 300 and the secondary molded part 400 are molded by a processing method for pressurizing and injecting an insulating resin into a metallic mold and filling the metallic mold with the resin, the so-called injection molding is disclosed.

The primary molded part 300 ensures insulation resistance by covering the exposed portion of the conductor 210 and covering all the exposed portion of the conductor 210 with the primary molded part 300. Also, the primary molded part 300 and the wire harness 200 are integrally covered with the secondary molded part 400, so that the primary molded part 300 is inhibited from being displaced relatively to the wire harness 200. Further, the fact that durability of a waterproof structure is achieved by preventing water through a gap between the coating part 220 and the primary molded part 300 or the secondary molded part 400 from entering the inside of the connector 100 by the first sealing member A and the second sealing member B made of a liquid seal material having viscosity, for example, silicone is disclosed.

### SUMMARY OF THE INVENTION

However, the connector 100 described in Japanese Patent Publication No. JP-A-2008-269858 requires the first sealing member A and the second sealing member B in order to ensure waterproofness of the connector 100. Assembly of the first sealing member A is required after the primary molded part 300 is molded, and also assembly of the second sealing member B is required after the secondary molded part 400 is molded. Therefore, a working process increases and also the number of components increases, and there were disadvantages of having a complicated structure and increasing cost.

Hence, the present applicant has eliminated the first sealing member A and the second sealing member B of the structure of the connector 100 described in Patent Reference 1, and has devised a structure and a method capable of ensuring waterproofness by the primary molded part 300 and the secondary molded part 400. A connector 100S as a prior invention and a manufacturing method of the connector 100S will be described based on FIGS. 3A and 3B.

FIG. 3A is a sectional view of the connector, and FIG. 3B is a sectional view including a metallic mold at the time of molding.

The connector 100S of the prior invention is arranged in the vicinity to which a conductor 210S of a wire harness 200S is exposed, and includes a primary molded part 300S with which a part of a coating part 220S of the wire harness 200S is covered, and a secondary molded part 400S with which a part of each of the primary molded part 300S and the coating part 220S is covered. The secondary molded part 400S is molded after the primary molded part 300S is molded on the coating part 220S. In that case, a top part 310S of the primary molded part 300S is supported and fixed by a metallic mold 500S. A resin material for molding the secondary molded part 400S is injected from a gate 530S into a space part 520S formed by the metallic mold 500S, the coating part 220S and the primary molded part 300S.

In such a prior invention, a gap D may first occur between the metallic mold 500S and the top part 310S of the primary molded part 300S. This is because a part of the primary molded part 300S cannot be pressed by the metallic mold 500S due to variations in dimensions of the coating part 220S of the wire harness 200S. Next, the top part 310S may be deformed by applying an injection pressure to an end face (end opposite to the top part 310S) of the primary molded part 300S at the time of injection molding of the secondary molded part 400S. This is because the pressure applied to the end face of the primary molded part 300S is transmitted to the inside of the primary molded part 300S, with the result that a part of the top part 310S is deformed and protrudes from the metallic mold 500S (see arrows Y1→Y2→Y3 of FIG. 3B).

Therefore, in the connector 100S of the prior invention, it was found that a waterproof function may be damaged by deforming a shape of the primary molded part 300S, particularly the top part 310S by a holding pressure, an injection pressure and a resin temperature at the time of injection in the case of molding the secondary molded part 400S. Also, when a shape of the secondary molded part 400S is complicated, there is a possibility that deformation of the primary molded part 300S cannot be inhibited on only molding conditions, and it was simultaneously found to have problem points of, for example, causing trouble such as a sink in the secondary molded part 400S.

As described above, the connector of the prior invention and the manufacturing method of the connector had a problem that waterproofness of the connector cannot be ensured since the primary molded part is deformed at the time of molding of the secondary molded part.

The invention has been implemented in view of the circumstances described above, and an object of the invention is to provide simplification of a connector and improvement in quality of the connector by preventing deformation of a top part of a primary molded part to achieve waterproofness.

In order to achieve the object described above, a connector according to the invention and a manufacturing method of the connector are characterized by the following (1) to (4).

(1) A connector having a primary molded part and a secondary molded part, the primary molded part and the secondary molded part being fixed integrally to the vicinity of a distal end of a wire harness,

wherein the primary molded part is formed so as to cover a part of a coating part of the wire harness in a position separated from the distal end and a stopper is formed in a top part which is one end of the primary molded part, and the secondary molded part is formed in the distal end so as to cover a part of the coating part and the primary molded part excluding the top part, and the stopper of the primary molded part is fitted into a fitting part of a metallic mold and is pressed by said fitting part at the time of formation of the secondary molded part

(2) A connector as set forth in (1), characterized in that the stopper has a concave shape recessed toward the coating part or a convex shape projected toward an upper side of the primary molded part.

(3) A connector as set forth in (1) or (2), characterized in that the secondary molded part is extended and molded so as to cover a conductor of the wire harness.

(4) A manufacturing method of a connector having a primary molded part and a secondary molded part, the primary molded part and the secondary molded part being fixed integrally to a distal end of a wire harness,

wherein the primary molded part, with which a part of a coating part of the wire harness is covered and in which a stopper is formed in a top part, is molded in a position separated from the distal end of the wire harness, and a metallic mold including a fitting part fitted into the stopper is set so that the fitting part presses the stopper, and the secondary molded part is injection-molded so as to cover a part of the coating part and a portion excluding the top part of the primary molded part.

According to the connector with the configuration of the above (1), the secondary molded part can be molded without deforming the primary molded part by surely fitting the stopper into the fitting part of the metallic mold when the secondary molded part is injection-molded. Therefore, the primary molded part makes close contact with the coating part and water can be prevented from entering a gap between the primary molded part and the coating part, and the connector with good waterproofness can be provided.

According to the connector with the configuration of the above (2), the stopper is accurately fitted into the fitting part of the metallic mold, and vertical and horizontal movement of the primary molded part at the time of molding of the secondary molded part can be inhibited.

According to the connector with the configuration of the above (3), properties of adhesion between the secondary molded part and the wire harness are increased, and the connector is tightly coupled to the wire harness.

According to the manufacturing method of the connector with the configuration of the above (4), after the primary molded part is adhesively fixed to the coating part of the wire harness, the top part of the primary molded part is surely pressed on the metallic mold and the fitting part of the metallic mold is fitted and supported into the stopper and thereby, deformation or movement of the primary molded part by an injection pressure at the time of molding of the secondary molded part is prevented, and a force of adhesion between the wire harness and the primary molded part after molding is increased, and the connector with good waterproofness can be manufactured.

### Advantageous Effects of Invention

According to the invention, at the time of molding of the secondary molded part, deformation of the primary molded part can surely be inhibited and the primary molded part becomes pressed and bonded by the secondary molded part and thereby, a force of adhesion between the wire harness and the primary molded part is enhanced, and the connector with good waterproofness and the manufacturing method of the connector can be provided.

The invention has been described above briefly. Further, the details of the invention will become more apparent by reading through a mode for carrying out the invention described below with reference to the accompanying drawings.

### BRIEF DESCRIPTION OF THE DRAWINGS

FIGS. 1A and 1B show a connector of a first embodiment according to the invention, and FIG. 1A is a sectional view, and FIG. 1B is a sectional view including a metallic mold.

FIGS. 2A to 2C show other embodiments of the connector according to FIGS. 1A and 1B, and FIG. 2A is a sectional view of a second embodiment, and FIG. 2B is a sectional view of a third embodiment, and FIG. 2C is a sectional view of a fourth embodiment.

FIGS. 3A and 3B show a connector according to a prior invention, and FIG. 3A is a sectional view, and FIG. 3B is a sectional view including a metallic mold.

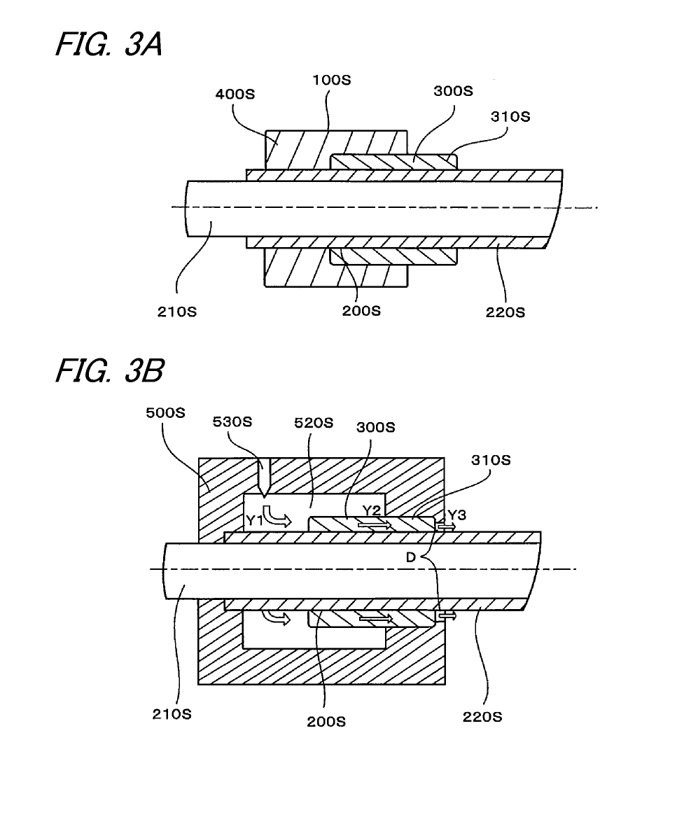

FIG. 4 is a sectional view of a conventional connector.

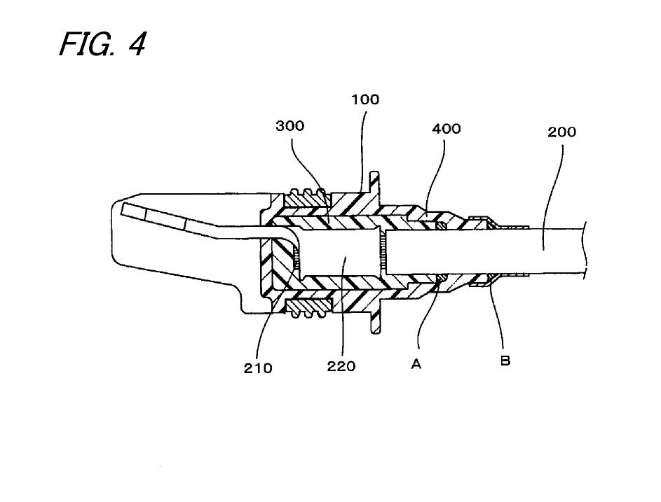

### DETAILED DESCRIPTION OF THE EXEMPLARY EMBODIMENTS

Preferred embodiments according to the invention will hereinafter be described based on the drawings.

### First Embodiment

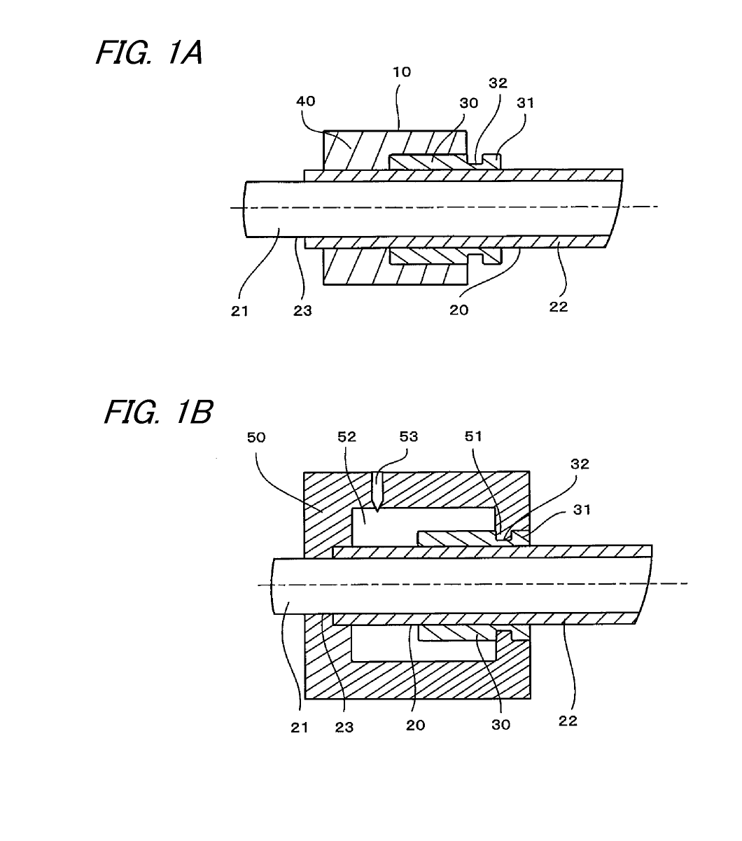

A connector 10 which is a first embodiment of the invention will be described based on FIGS. 1A and 1B.

FIGS. 1A and 1B show the connector of the first embodiment according to the invention, and FIG. 1A is a sectional view, and FIG. 1B is a sectional view including a metallic mold. The connector 10 is fixed to a wire harness 20. The wire harness 20 includes a conductor 21 and a coating part 22, and the connector 10 is fixed in the vicinity of a distal end 23 of the wire harness 20 to which the conductor 21 is exposed. On the other hand, the connector 10 is configured to include a primary molded part 30 and a secondary molded part 40.

The primary molded part 30 is made of thermosetting resin elastomer, and is annularly molded by injection molding so as to cover the whole periphery of a part of the coating part 22 in a position separated from the distal end 23 of the wire harness 20 in a longitudinal direction of the wire harness 20, and is fixed on the coating part 22. Also, a stopper 32 is formed in a top part 31 (an end opposite to the exposed portion side of the conductor 21) which is one end of the primary molded part 30. In the first embodiment, the stopper 32 is formed in a concave shape recessed to the side of the coating part 22.

The secondary molded part 40 is made of a deformation-resistant insulating resin such as a polyester resin or a polyamide resin, and is annularly molded by injection molding so as to cover the whole peripheries of a part of the coating part 22 in the vicinity of the distal end 23 of the wire harness 20 and the portion excluding the top part 31 of the primary molded part 30, and is fixed so as to press the primary molded part 30. Also, the secondary molded part 40 has a function as a housing of the connector 10.

The connector 10 is formed in the following procedure (see FIG. 1B).

Step 1: The primary molded part 30 is annularly molded by injection molding so as to cover a part of the coating part 22 in a state separated from the distal end 23 of the wire harness 20. In that case, the stopper 32 is formed in the top part 31 of the primary molded part 30.

Step 2: The wire harness 20 and the primary molded part 30 are pinched by a metallic mold (a cavity core) 50. In that case, the stopper 32 of the primary molded part 30 is fitted into a fitting part 51 formed in the metallic mold 50, and the top part 31 of the primary molded part 30 is pressed by the metallic mold 50. Simultaneously, a space part 52 is formed inside the metallic mold 50 by the metallic mold 50, the wire harness 20 and the primary molded part 30.

Step 3: A secondary molding resin material is injected into the space part 52 through a gate 53 for resin injection of the metallic mold 50, and the secondary molded part 40 is molded. At the time of injection molding, an injection pressure is applied to an end face of the primary molded part 30, but the stopper 32 is fitted into the fitting part 51 of the metallic mold 50 and the stopper 32 is pressed, so that an external force applied to the top part 31 is reduced by the fitting part 51 and deformation of the top part 31 can be inhibited.

The stopper 32 of the primary molded part 30 is fitted into the fitting part 51 of the metallic mold 50 and thereby, an external force by which the injection pressure acts on the top part 31 of the primary molded part 30 is reduced by the fitting part 51, and deformation of the top part 31 can be prevented. Therefore, a state of adhesion of the primary molded part 30 to the coating part 22 is held, and water can be prevented from entering a gap between the primary molded part 30 and the coating part 22. Also, the secondary molded part 40 is molded so as to surround the primary molded part 30, and the primary molded part 30 made of elastomer is elastically pressed and bonded and thereby, the primary molded part 30 can be brought into closer contact with the wire harness 20.

### Second Embodiment

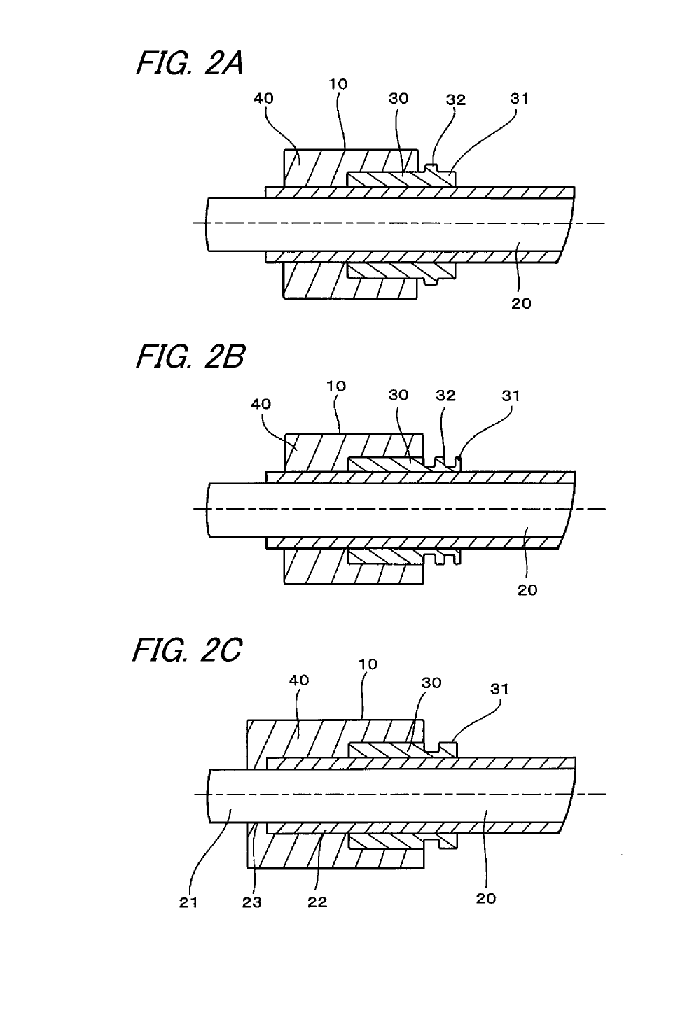

FIG. 2A is a sectional view showing a second embodiment. A stopper 32 formed in a top part 31 of a primary molded part 30 is formed in a convex shape projected toward the upper side of the primary molded part 30. When a wall thickness of the primary molded part 30 is thin, the size of the stopper 32 can be ensured and the stopper 32 can be fitted into a fitting part 51 of a metallic mold 50 more tightly as compared with the first embodiment.

### Third Embodiment

FIG. 2B is a sectional view showing a third embodiment. A stopper 32 formed in a top part 31 of a primary molded part 30 is formed in plural concave shapes recessed toward a coating part 22. Since an external force by which an injection pressure acts on the top part 31 of the primary molded part 30 is reduced by more fitting parts 51, deformation of the top part 31 is inhibited more. In addition, the stopper 32 is described as the concave shapes, but convex shapes may be used.

### Fourth Embodiment

FIG. 2C is a sectional view showing a fourth embodiment. A secondary molded part 40 is molded so as to cover a distal end 23 of a wire harness 20. That is, the secondary molded part 40 is annularly molded by injection molding so as to cover the whole peripheries of a part of a conductor 21 and a coating part 22 and the portion excluding a top part 31 of a primary molded part 30. Since the secondary molded part 40 makes close contact with the conductor 21, a connector 10 is fixed to the wire harness 20 more tightly.

As described above, the connector 10 according to the embodiments of the invention is characterized in that the connector 10 including the primary molded part 30 and the secondary molded part 40 is fixed integrally to the distal end 23 of the wire harness 20 and the primary molded part 30 is formed so as to cover a part of the coating part 22 of the wire harness 20 in a position separated from the distal end 23 and the secondary molded part 40 is formed in the vicinity of the distal end 23 so as to cover a part of the coating part 22 and the primary molded part 30 excluding the top part 31 and the fitting part 51 of the metallic mold 50 fits and presses the stopper 32 of the primary molded part 30 at the time of molding of the secondary molded part 40.

According to this configuration, the secondary molded part 40 can be molded without deforming the top part 31 of the primary molded part 30 by fitting the stopper 32 into the fitting part 51 of the metallic mold 50 when the secondary molded part 40 is injection-molded. Therefore, the primary molded part 30 makes close contact with the coating part 22 and water can be prevented from entering a gap between the primary molded part 30 and the coating part 22, and the connector 10 with good waterproofness can be provided.

Also, the connector 10 according to the embodiments of the invention is characterized in that the stopper 32 is formed in a concave shape recessed toward the coating part 22 or a convex shape projected toward the upper side of the primary molded part 30. According to this configuration, the stopper 32 is accurately fitted into the fitting part 51 of the metallic mold 50, and vertical and horizontal movement of the primary molded part 30 at the time of molding of the secondary molded part 40 can be inhibited.

Further, the connector 10 according to the embodiments of the invention is characterized in that the secondary molded part 40 is extended and molded so as to cover the conductor 21 of the wire harness 20. According to this configuration, properties of adhesion between the secondary molded part 40 and the wire harness 20 are increased, and the connector 10 is tightly coupled to the wire harness 20.

A manufacturing method of the connector 10 according to the embodiments of the invention is characterized in that the primary molded part 30, with which a part of the coating part 22 is covered and in which the stopper 32 is formed in the top part 31, is first molded in a position separated from the distal end 23 of the wire harness 20 and next, the metallic mold 50 including the fitting part 51 fitted into the stopper 32 is set so that the fitting part 51 presses the stopper 32 and then, the secondary molded part 40 is injection-molded so as to cover a part of the coating part 22 and the portion excluding the top part 31 of the primary molded part 30.

According to this manufacturing method, after the primary molded part 30 is adhesively fixed to the coating part 22 of the wire harness 20, the top part 31 of the primary molded part 30 is pressed on the metallic mold 50 and the fitting part 51 of the metallic mold 50 is fitted and supported into the stopper 32. Consequently, the top part 31 of the primary molded part 30 can be inhibited from being deformed by an injection pressure at the time of molding of the secondary molded part 40 and also, the primary molded part 30 is not moved. As a result, a force of adhesion between the wire harness 20 and the primary molded part 30 after molding is increased, and the connector 10 with good waterproofness can be manufactured.

In addition, the invention is not limited to the embodiments described above, and modifications, improvements, etc. can be made properly. Moreover, as long as the invention can be achieved, the number of components, materials, shapes, dimensions, numerical values, modes, arrangement places, etc. of each component in the embodiments described above are arbitrary and are not limited.

The stopper 32 of the primary molded part 30 is described in detail as the concave shape or the convex shape, but is not limited to the embodiments of the invention as long as movement of the primary molded part 30 can be inhibited by the fitting part 51 of the metallic mold 50.

The present invention is useful for simplification of a connector and improvement in quality of the connector by preventing deformation of a top part of a primary molded part to achieve waterproofness.

What is claimed is:

1. A connector having a primary molded part and a secondary molded part, the primary molded part and the secondary molded part being fixed integrally to the vicinity of a distal end of a wire harness,
wherein the primary molded part is formed so as to cover a part of a coating part of the wire harness in a position separated from the distal end and a stopper is formed in a top part which is one end of the primary molded part,
and the secondary molded part is formed in the distal end so as to cover a part of the coating part and the primary molded part excluding the top part,
and the stopper of the primary molded part is fitted into a fitting part of a metallic mold and is pressed by said fitting part at the time of formation of the secondary molded part.

2. A connector as claimed in claim 1, wherein the stopper has a concave shape recessed toward the coating part or a convex shape projected toward an upper side of the primary molded part.

3. A connector as claimed in claim 1, wherein the secondary molded part is extended and molded so as to cover a conductor of the wire harness.

4. A manufacturing method of a connector having a primary molded part and a secondary molded part, the primary molded part and the secondary molded part being fixed integrally to a distal end of a wire harness,
wherein the primary molded part, with which a part of a coating part of the wire harness is covered and in which a stopper is formed in a top part, is molded in a position separated from the distal end of the wire harness, and a metallic mold including a fitting part fitted into the stopper is set so that the fitting part presses the stopper, and the secondary molded part is injection-molded so as to cover a part of the coating part and a portion excluding the top part of the primary molded part.

5. A connector as claimed in claim 1, wherein the stopper and the fitting part are formed at least upper and lower sides and top and bottom sides with respect to the center axis of the connector.
